(19) United States
(12) Patent Application Publication
(10) Pub. No.: US 2015/0163268 A1
(43) Pub. Date: Jun. 11, 2015

(54) System and Methods for Dynamically Loading a Compatible Media Player Based on a User's Environment

(71) Applicant: Lexmark International, Inc., Lexington, KY (US)

(72) Inventor: David Robinson Wegman, San Francisco, CA (US)

(73) Assignee: Lexmark International, Inc., Lexington, KY (US)

(21) Appl. No.: 14/145,323

(22) Filed: Dec. 31, 2013

Related U.S. Application Data
(60) Provisional application No. 61/914,667, filed on Dec. 11, 2013.

(51) Int. Cl. H04L 29/06

(52) U.S. Cl. CPC H04L 65/60; H04L 67/42

(57) ABSTRACT

A method for dynamically loading a compatible media player for use by a computing device for playing a media item that includes receiving a media identifier and a profile of the computing device from the computing device; loading the media item corresponding to the media identifier; checking for the compatible media player by determining if the computing device profile includes one or more attributes associated with a media player; and if the computing device profile includes the one or more attributes, returning the media player to the computing device as the compatible media player.

### CROSS REFERENCES TO RELATED APPLICATIONS

The present application is related to and claims priority under 35 U.S.C. 119(e) from U.S. provisional patent application No. 61/914,667, filed Dec. 11, 2013, entitled, “System and Methods for Dynamically Loading a Compatible Media Player Based on a User's Environment,” the contents of which is hereby incorporated by reference herein in its entirety.

### STATEMENT REGARDING FEDERALLY SPONSORED RESEARCH OR DEVELOPMENT

None.

### REFERENCE TO SEQUENTIAL LISTING, ETC

None.

### BACKGROUND

1. Technical Field

The present disclosure relates generally to systems and methods for loading a compatible media player to a user's client and, more particularly, loading a compatible media player to a user's client based on the user's current browser and/or environment.

2. Description of the Related Art

There is a variety of web-based media players available today such as, for example, Flash from Adobe Systems, Inc., HTML5, and Silverlight from Microsoft Corporation. When a user navigates to a web page containing an embedded media item, some formats of web-based media players might be supported by the user's current device while others may have partial or no support, depending on the user's computing environment. The user's device, operating system, web browser, installed software, and many other factors, all affect whether a media player may be used to play a media item on the user's device.

Traditionally, a media player is directly embedded in a web site and the media player only loads on the user's device if the player is supported by the user's environment. Users whose environment does not support the media player will not be able to load the media player or view the embedded media item.

Accordingly, there is a need for a system and one or more methods of allowing a user to load a compatible media player and view the embedded media item regardless of the user's environment. There is also a need for a method that allows a user to view a media item using any player that is supported by the user's current computing environment.

### SUMMARY

A system and methods for dynamically loading a compatible media player based on a user's environment are disclosed. The system includes a client device that may be used by a user to access a web page having an embedded media item, and a server that receives a request from the client device for the compatible player. The request comprises a media identifier, a player profile identifier and a user profile. The server receives the request and loads the media item file corresponding to the media identifier. The server also checks for a compatible media player that may be used by the client device to play the media item by checking if the user profile includes one or more attributes that are associated with the media player.

In an alternative example embodiment, checking for a compatible media player includes checking one or more player selectors associated with the player profile identifier for a rule that corresponds to the user profile received from the client device. The user profile includes one or more attributes of the client device which may be used to determine if the client device has the capabilities to use the media player for playing the embedded media item. If at least one rule is determine to correspond to the user profile such that the client device attributes satisfy the rule, the media player associated with the rule may be identified as the compatible media player for the client device. The identified compatible media player may then be sent from the server to the client device. If no compatible media player is identified, an error message may be invoked and sent back to the client device in response to the request.

From the foregoing disclosure and the following detailed description of various example embodiments, it will be apparent to those skilled in the art that the present disclosure provides a significant advance in the art of methods for dynamically loading a compatible player based on a user's environment. Additional features and advantages of various example embodiments will be better understood in view of the detailed description provided below.

### BRIEF DESCRIPTION OF THE DRAWINGS

The above-mentioned and other features and advantages of the present disclosure, and the manner of attaining them, will become more apparent and will be better understood by reference to the following description of example embodiments taken in conjunction with the accompanying drawings. Like reference numerals are used to indicate the same element throughout the specification.

FIG. 1 shows an example system that can be utilized to dynamically load a compatible media player and provide media content to one or more client devices based on the user's current environment.

FIG. 2 discloses an example method of dynamically loading a compatible media player to a user's device based on the user's current environment.

### DETAILED DESCRIPTION OF THE DRAWINGS

It is to be understood that the disclosure is not limited to the details of construction and the arrangement of components set forth in the following description or illustrated in the drawings. The disclosure is capable of other example embodiments and of being practiced or of being carried out in various ways. For example, other example embodiments may incorporate structural, chronological, process, and other changes. Examples merely typify possible variations. Individual components and functions are optional unless explicitly required, and the sequence of operations may vary. Portions and features of some example embodiments may be included in or substituted for those of others. The scope of the disclosure encompasses the appended claims and all available equivalents. The following description is, therefore, not to be taken in a limited sense, and the scope of the present disclosure is defined by the appended claims.

Also, it is to be understood that the phraseology and terminology used herein is for the purpose of description and should not be regarded as limiting. The use herein of “including,” “comprising,” or “having” and variations thereof is meant to encompass the items listed thereafter and equivalents thereof as well as additional items. Further, the use of the terms “a” and “an” herein do not denote a limitation of quantity but rather denote the presence of at least one of the referenced item.

In addition, it should be understood that example embodiments of the disclosure include both hardware and electronic components or modules that, for purposes of discussion, may be illustrated and described as if the majority of the components were implemented solely in hardware.

It will be further understood that each block of the diagrams, and combinations of blocks in the diagrams, respectively, may be implemented by computer program instructions. These computer program instructions may be loaded onto a general purpose computer, special purpose computer, or other programmable data processing apparatus to produce a machine, such that the instructions which execute on the computer or other programmable data processing apparatus may create means for implementing the functionality of each block or combinations of blocks in the diagrams discussed in detail in the description below.

These computer program instructions may also be stored in a non-transitory computer-readable medium that may direct a computer or other programmable data processing apparatus to function in a particular manner, such that the instructions stored in the computer-readable medium may produce an article of manufacture, including an instruction means that implements the function specified in the block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus implement the functions specified in the block or blocks.

Accordingly, blocks of the diagrams support combinations of means for performing the specified functions, combinations of steps for performing the specified functions and program instruction means for performing the specified functions. It will also be understood that each block of the diagrams, and combinations of blocks in the diagrams, can be implemented by special purpose hardware-based computer systems that perform the specified functions or steps, or combinations of special purpose hardware and computer instructions.

Disclosed are an example system and methods for dynamically loading a compatible media player based on the user's current computing environment. The system includes a user's device for use in loading a media player to play an embedded media item, a server for determining a media player compatible for use with the user's device, and one or more databases that store information that allows the server to return the compatible media player to the user's device. One example method includes detecting a user's navigation to a web page containing an embedded media item; sending a server information relating to the user's current environment, an identifier of the media item being accessed, and an identifier of the media player profile; the server determining a compatible media player based on the information received from the user's device; and returning the compatible media player for loading in user's device.

For the purposes of the present disclosure, media content or media item may refer to web-based electronic media such as, for example, a video or audio file, that may be requested by a user of a device from a media server to be played on the device using a media player. Media content may be a combination of different content formats such as audio, text, still images, video, animation and other content forms that may or may include interactivity content forms. Media content may be accessed, displayed and/or played by information content processing devices, such as electronic devices, through the use of a media player.

Media player may refer to computer software for use in playing back media content. Media players may play media files in at least one of an audio or a video format. In one example embodiment, media players may be located in a web page and rendered and displayed as part of the web page upon receiving the media player and the media content to be played from a server. Typically, web-based media players require at least one plug-in installed in the device in order to play the media item having a specific format. Users usually install the plug-ins or other applications prior to viewing the media using the media players.

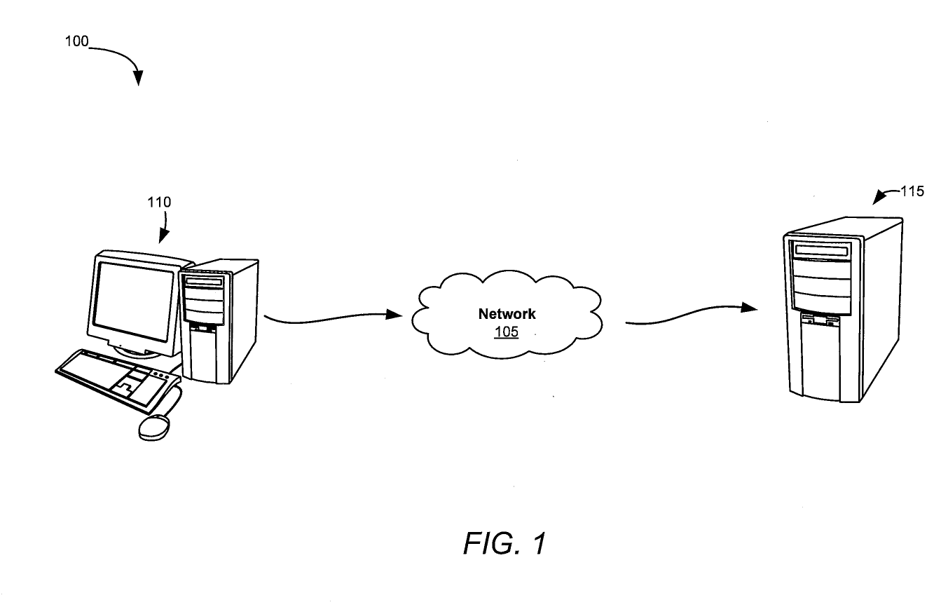

FIG. 1 shows one example system 100 that can be utilized to dynamically load a compatible media player and provide media content to one or more client devices based on the user's current environment. System 100 allows a media server to dynamically provide the suitable media player that can be immediately used by the user of the requesting device, regardless of whether or not the device is installed with the application typically required to view the media item using the media player. System 100 includes a network 105 that connects a client device 110 and a server 115.

Network 105 may be any network, communications network, or network/communications network system such as, but not limited to, a peer-to-peer network, a hybrid peer-to-peer network, a Local Area Network (LAN), a Wide Area Network (WAN), a public network such as the Internet, a private network, a cellular network, a combination of different network types, or other wireless, wired, and/or a wireless and wired combination network capable of allowing communication between two or more computing systems, as discussed herein, and/or available or known at the time of filing, and/or as developed after the time of filing. Client device 110 and server 115 may be connected to network 105 through one or more network interfaces that allow each of the devices to send and receive information to and from the other.

Client device 110 may be any computing device that is used by a user to access a web page and view an embedded media content using a media player. Client device 110 may be a personal computer and/or a mobile device such as a smart phone, or a tablet computer, onto which media content may be downloaded for playing. Client device 110 may include a non-transitory computer readable storage medium installed with an application such as, for example, a web browser that may be used by the user of client device 110 to access a web page having a media content to be played. A web browser is a software application installed in client device 110 that allows a user to view and interact with images, text and other information typically located on a web page at a website on a LAN or on a WAN such as, for example, the World Wide Web.

Server 115 may be a media content provider that provides media content to client device 110 upon request of client device 110. One or more media files in at least one format may be stored in server 115 along with information regarding the type of media player to be used for a particular media file format and the user's current computing environment. It will be known in the art that using a web browser to access a web page having media content may include sending a request from client device 110 to server 115 for the media content. In the present disclosure, server 115 retrieves the media content requested by client device 110 and also determines a compatible media player that may be immediately executed on client device 110 for use in playing the retrieved media content from server 115.

Server 115 may include one or more databases that store data models to be used in dynamically loading a compatible media player for use in client device 110. The data model may include a media player reference, a media player selector, a player profile, a user profile, a media item and a media asset. The media player reference describes a specific player implementation that details the implementation of one or more media players to be used for media content in a specific format and has the requirements for the user's current computer environment. For example, the media player reference may include a first media player that is implemented using Flash and can be used to display media content in an Adobe Shockwave Flash (SWF) file format, thereby requesting an application installed in the user device that will support files implemented in Flash such as, for example, a Flash plug-in. A second media player may also be described in the media player reference that describes video playback using the HTML5 (Hypertext Markup Language 5) standard. Other examples of player implementation, such as those requiring the Microsoft Silverlight application framework, are known in the art.

A media player selector may consist of a rule and a player reference. The rule may be set at embed time such that a player reference that details a specific player implementation is chosen for an embedded media content or for a set of users. A player profile consists of an identifier and a list of player selectors for the media content. Player profiles may be created and configured by an administrative user such that a player profile includes one or more settings that the administrative user wishes to be used for users of one or more client devices. Administrative users that wish to customize which players are likely to be shown to which end-users may also be configured by assigning a player profile on a media item at embed time such that the user accessing the media item may send a request to server 115 that includes a user profile, a media item identifier and a player profile identifier, as will be discussed in greater detail below.

A user profile includes details about the user's current environment as received from the user upon client device 110 sending a request for the media content and media player to server 115. The user profile may include, but is not limited to, an operating system, an operating system version, a browser name, a browser version, and the names and/or versions of additional software that have been installed on client device 110 used by the user. A media item consists of an identifier and a list of media assets, wherein a media asset consists of media content that has been encoded into a specific media format such as, for example, Flash, H.264, or WebM. It will be understood that the specific media format has a set of one or more playback requirements for client device 110 that requests for the media item.

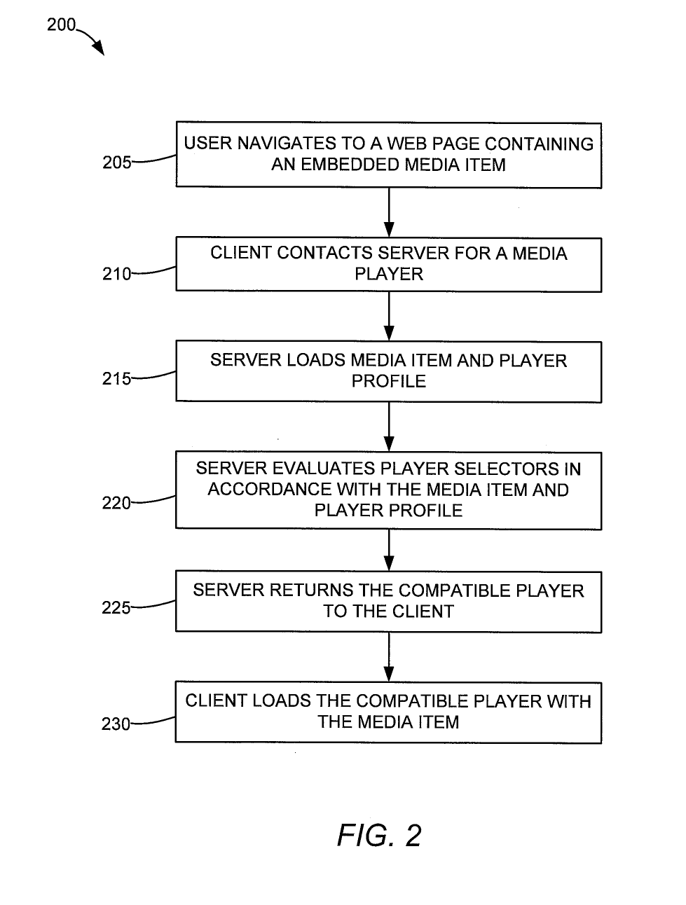

FIG. 2 discloses an example method 200 of dynamically loading a compatible media player to a user's device based on the user's current environment. Method 200 may be performed by example system 100 of FIG. 1 using one or more computer instructions stored in client device 110 and server 115. Example method 200 allows a web site's administrative user to define rules controlling which media player is loaded in any particular scenario. Using this example method, the web site may automatically and dynamically support a broad array of user environments.

At block 205, a user of client device 110 may navigate to a web page containing an embedded media item. For example, a user may access a web page that includes an embedded video file that the user wishes to play using the web browser installed in client device 110.

At block 210, a client in the web page may contact server 115. The client may be a piece of code in the web page that sends a request to server 115 upon a user navigating to the web page. In one example embodiment, the user may provide an indication that he or she wishes to view or play the embedded video file prior to the client contacting server 115. The request sent to server 115 may include the current user profile, the media item identifier corresponding to the media item accessed by the user, and the player profile identifier relating to the accessed media item.

At block 215, server 115 loads the media item corresponding to the media item identifier included in the request. Loading the media item may include interrogating a database for the media item using the media item identifier. Server 115 may also load the player profile using the player profile identifier. Loading the player profile includes loading a list of player selectors which includes a rule and a player reference that details the one or more media players to be used for the loaded media item.

At block 220, server 115 may evaluate the list of player selectors associated with the received player profile identifier. Evaluating the list of player selectors may include evaluating each of the player selectors in order by comparing the current user profile to the player selector's player preference. For example, the current user profile received may indicate that client device 110 used by the user to request for the media item and media player is installed with a Flash player but does not have a Silverlight plug-in that could run media written under the Microsoft Silverlight application framework. As such, server 115 may identify a media player reference that requires a Flash plug-in to be the compatible media player for the requesting client device 110.

At block 225, once the compatible player reference is found, the corresponding player is returned from server 115 to client device 110 in response to the request. Server 115 may also return the requested media item along with the compatible player to the requesting client device 110 for loading using the compatible media player (at block 230).

In one alternative example embodiment, server 115 may store a media item in varying formats such that server 115 determines the media content format supported by client device 110 and returns the compatible media content format to client device 110 in response to the request.

One example embodiment of choosing a compatible media player determined using one or more selectors associated with a player profile will be discussed using the example player profiles below.

Player Profile 1:

Selector A
Rule: operating_system[name]==“Windows” && operating_system[version]==“7” && browser[name]==“Internet Explorer” and && browser[version]==“8”
Player reference: HTML5

Selector B:
Rule: plugins[flash][version]>=9
Player reference: Flash

Selector C:
Rule: browser[name]==“Chrome”∥browser[name]==“Firefox”∥browser[name]==“Safari”
Player reference: HTML5

Player Profile 2

Selector A
Rule: plugins[flash][version]>=7
Player reference: Flash

Selector B:
Rule: operating_system[name]==“Windows” && operating_system[version]==“7” && browser[name]==“Internet Explorer” and && browser[version]==“8”
Player reference: HTML5

In example Player Profile 1, if the current user profile received by server 115 from client device 110 indicates that the device has a Windows 7 operating system, Internet Explorer 8, and Flash 9 application installed, Selector A will be chosen and an HTML5 player may be determined by server 115 to be the compatible player for client device 110 that meets the rules set for Selector A. Alternatively, if the current user profile indicates an end-user having Windows 7, Google Chrome browser and Flash 9 installed, Selector B will be chosen and a Flash player will be returned to the user. An end-user with Windows 7 and Chrome, but not having Flash installed on its device, would have Selector C chosen and an HTML5 player returned for loading to the user's client device 110.

Meanwhile, when Player Profile 2 is used, an end-user with Windows 7, Internet Explorer 8 and Flash 9 would have selector #1 chosen, and a Flash player will be returned as the compatible media player. Alternatively, if the user profile indicates a Windows 7 operating system and Chrome installed, but not having Flash installed, Selector B will be chosen, and HTML5 returns as the compatible player.

In an alternative example embodiment, if more than one media player is determined to be compatible with the requesting client device, the top ranked player will be returned. The top ranked player is determined by querying each of the player selectors in the player profile in order, and choosing the first player for which the rule evaluates as being true. For example, if the received player profile identifier is Player Profile 1 and the first rule that evaluated to true against the received user profile is Selector A, the HTML 5 player is chosen.

In another alternative example embodiment, if none of the players are determined to be compatible such that current user profile provides no indication that at least one of the media players in the player selector can be supported by the requesting client device 110, a failure scenario may be invoked such as, for example, an error message that will be returned from server 115 to client device 110.

The compatible media player will be selected based on the user's environment as indicated by the current user profile sent from client device 110 to server 115 upon requesting for the media item and media player. The compatible media player will be based on how player profiles have been configured. An administrative user may create one or more player profiles to encapsulate the settings desired for a particular client device and in order to customize which players are shown to which end-users.

It will be understood that the example applications described herein are illustrative and should not be considered limiting. It will be appreciated that the actions described and shown in the example flowcharts may be carried out or performed in any suitable order. It will also be appreciated that not all of the actions described in FIG. 2 need to be performed in accordance with the example embodiments of the disclosure and/or additional actions may be performed in accordance with other embodiments of the disclosure.

Many modifications and other example embodiments of the disclosure set forth herein will come to mind to one skilled in the art to which these disclosure pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A method for dynamically loading a compatible media player for use by a computing device for playing a media item, comprising:
receiving a media identifier and a profile of the computing device from the computing device;
loading the media item corresponding to the media identifier;
checking for the compatible media player by determining if the computing device profile includes one or more attributes associated with a media player; and
if the computing device profile includes the one or more attributes, returning the media player to the computing device as the compatible media player.

2. The method of claim 1, wherein the checking for the compatible media player includes comparing if the profile of the computing device indicates software installed on the computing device matches software required by the media player.

3. The method of claim 2, wherein if the profile of the computing device indicates the software installed on the computing device matches the software required by the media player, determining that the media player is the compatible media player for immediate use by the device.

4. The method of claim 1, wherein the receiving further includes receiving a player profile identifier corresponding to a player profile configured by an administrative user, the player profile identifier being used in selecting a compatible media player for use by the computing device for playing the media item.

5. The method of claim 1, wherein if the computing device profile does not include the one or more attributes associated with the media player, returning an error message to the computing device indicating unavailability of the compatible media player for the computing device.

6. The method of claim 1, wherein the receiving further includes receiving the media identifier and the computing device profile after the user navigates to a web page having the media item.

7. A system for dynamically loading a compatible media player based on a user's environment, comprising:
a client device for use by the user in navigating to a web page having an embedded media item; and
a server communicatively connected to the client device for:
receiving a user profile and a player profile identifier from the client device;
evaluating if the user profile includes one or more attributes associated with a media player; and
if the user profile includes the one or more attributes associated with the media player, returning the media player to the client device as the compatible media player for use in playing the embedded media item.

8. The system of claim 7, wherein the client device sends the user profile and the player profile identifier to the server upon detecting that the user has navigated to the web page having the embedded media item.

9. The system of claim 7, wherein the client device sends the user profile and the player profile identifier to the server using a client code from the web page having the embedded media item.

10. The system of claim 7, wherein the one or more attributes of the user profile includes at least one software program installed in the client device for viewing the embedded media item.

11. The system of claim 7, wherein the player profile identifier includes one or more pairs of a rule and a media player associated with the rule.

12. The system of claim 11, wherein the rule includes requires one or more attributes from the user profile, the one or more attributes used in determining the compatible media player for the client device.

13. The system of claim 11, wherein the rule includes at least one software program that should be installed in client device in order for the associated media player to be determined as the compatible media player for the client device.

14. The system of claim 11, wherein the evaluating includes evaluating if the user profile satisfies at least one rule from the one or more pairs of rule and associated media player.

15. The system of claim 7, wherein the one or more attributes includes an operating system of the client device.

16. The system of claim 7, wherein the one or more attributes includes a version of a software program installed in the client device.

17. A non-transitory computer-readable storage medium containing computer executable instructions for dynamically loading a compatible media player for use by a computing device for playing a media item, the computer executable instructions comprising instructions to:
receive client device information and a player profile identifier from the client device;
evaluate the user profile against one or more rules associated with the player profile identifier, each rule having an associated media player;
if the user profile satisfies at least one rule from the one or more rules, return the media player associated with the at least one rule to the client device as the compatible media player for use by the computing device for playing the media item; and
if the user profile does not satisfy a rule from the one or more rules, return an error message to the client device.

18. The computer-readable storage medium of claim 17, wherein the instruction to evaluate the client device information against the one or more rules includes evaluating whether the client device includes at least one software program installed on the client device that would allow the client device to play the media item using the associated media player.

19. The computer-readable storage medium of claim 17, wherein the instruction to receive includes receiving the client device information and the player profile identifier as a request from the client device upon a user navigating a web page having the media item.

20. The computer-readable storage medium of claim 17, wherein the instruction to return the error message to the client device includes returning an indication that the client device lacks at least one attribute required to play the media item embedded in a web page accessed by the user using the client device.
